(19) United States
(12) Patent Application Publication
(10) Pub. No.: US 2015/0152747 A1
(43) Pub. Date: Jun. 4, 2015

(54) EXTERNAL HEAT ENGINES

(71) Applicant: DYVERGA ENERGY CORPORATION, Kitchener (CA)

(72) Inventors: Harold Emerson Godwin, Fergus (CA); Harold Devisser, Caledon East (CA)

(21) Appl. No.: 14/400,737

(22) PCT Filed: May 13, 2013
(86) PCT No.: PCT/CA2013/000467

§ 371 Date: Nov. 12, 2014

Related U.S. Application Data
(60) Provisional application No. 61/646,647, filed on May 14, 2012.

(51) Int. Cl. F01K 3/02; F01K 7/00; F01K 13/02; F01K 3/12

(52) U.S. Cl. CPC F01K 3/02; F01K 3/12; F01K 7/00; F01K 13/02

(57) ABSTRACT

An engine includes a plurality of vessels coupled to a rotatable frame and arranged about a center of rotation of the rotatable frame. Conduits connect pairs of vessels to allow mass to move between the pairs of vessels to generate a gravitational moment about the center of rotation. Each pair of vessels can have a pathway for conveying fluid heated by a heat source. The pathway extends from the heat source to a lower vessel of the pair, and can further extend from the lower vessel to an upper vessel of the pair. The pathway can be configured to expand volatile material in the lower vessel to tend to push the mass from the lower vessel into the upper vessel, and to contract volatile material in the upper vessel to tend to suck the mass into the upper vessel from the lower vessel. Vessels can be controllably connected to pressures to move mass via controllable pressure and temperature distribution systems.

This application claims priority to U.S. 61/646,647, which is incorporated herein by reference.

### TECHNICAL FIELD

The embodiments described herein relate to heat engines, and more specifically, to systems, apparatus, and methods for generating power with external heat engines.

### Introduction

Extraction of energy from heat sources, such as water heated by solar, geothermal, or industrial processes, and conversion of this energy to rotational or other forms of useful power is often inefficient or impractical.

A number of attempts have been made to provide apparatus that make the energy extraction more practical. For example, Gould (U.S. Pat. No. 4,570,444) describes a solar-powered motor with a wheel-like rotor having a rim separated into hollow compartments. The rotor is designed to revolve around a horizontal axis while containing a volatile liquid in some of its rim compartments. The rotor has a hub, also with separate compartments, and hollow spokes interconnecting the hub with the rim compartments. The interior of the rotor is designed to receive a compressed gas in its hub and sequentially route it, through the hollow spokes, to rim compartments on one side of the rotor axis. When the compressed gas makes contact with the liquid surface in that part of the rim it exerts pressure on that surface. The pressure on the liquid surface forces the liquid to the opposite side of the rotor and into the rim, through an interconnecting series of passageways in the spokes and hub, at a level higher than its original level. This results in an imbalance of weight on one side of the rotor that causes the rotor to turn or rotate under the influence of gravity in a direction tending to restore its weight balance. The rotor continues to rotate as long as the compressed gas is fed into its hub. The compressed gas can be the vapor phase of the volatile liquid in the rotor.

Yoo, et al. (U.S. Pat. No. 6,240,729) on the other hand describes an apparatus for converting thermal energy to mechanical motion including a frame mounted onto an axle above a heat source. A flow circuit including at least three elongate chambers connected by fluid conduits is mounted onto the frame, and one-way valves provided in the flow circuit permit one-way fluid flow within the flow circuit. The heat source heats a motive fluid contained within the chambers beyond its boiling point, which increases the vapor pressure within the heated chamber, thereby forcing fluid out of the chamber and into the chamber immediately downstream in the flow circuit. The increased weight of the downstream chamber creates a torque about the axle, rotating the frame in an upstream direction.

Furthermore, Iske (U.S. Pat. No. 243,909) describes in a motor, a straight tube having a receptacle at each end and allowing the passage of enclosed volatile liquid from one receptacle to the other under the action of heat.

There remains a need for an improved way for converting energy to useful work.

### SUMMARY

An engine includes a plurality of vessels coupled to a rotatable frame and arranged about a center of rotation of the rotatable frame. Conduits connect pairs of vessels to allow mass to move between the pairs of vessels to generate a gravitational moment about the center of rotation. Temperature and/or pressure distribution in the engine can be controlled.

### BRIEF DESCRIPTION OF THE DRAWINGS

FIG. 1 is a schematic view of an engine configured to extract energy from a heat source according to an embodiment;

FIG. 2 is a cross-sectional view of one of the vessels;

FIG. 3 is a cross-sectional view of the manifold;

FIG. 4 is a diagram showing fluid flow in the engine according to a first configuration;

FIG. 5 is a diagram showing fluid flow in the engine according to a second configuration;

FIG. 6 is a diagram showing fluid flow in the engine according to a third configuration;

FIG. 7 is a schematic view is an engine according to another embodiment;

FIG. 8 is a vessel according to another embodiment;

FIG. 9 is a manifold according to another embodiment; and

FIG. 10 is a schematic view of an engine configured to extract energy from a heat source according to another embodiment.

### DETAILED DESCRIPTION

The engines described herein may be known as external heat engines, in that heat can be applied across the boundary of the volume that performs work.

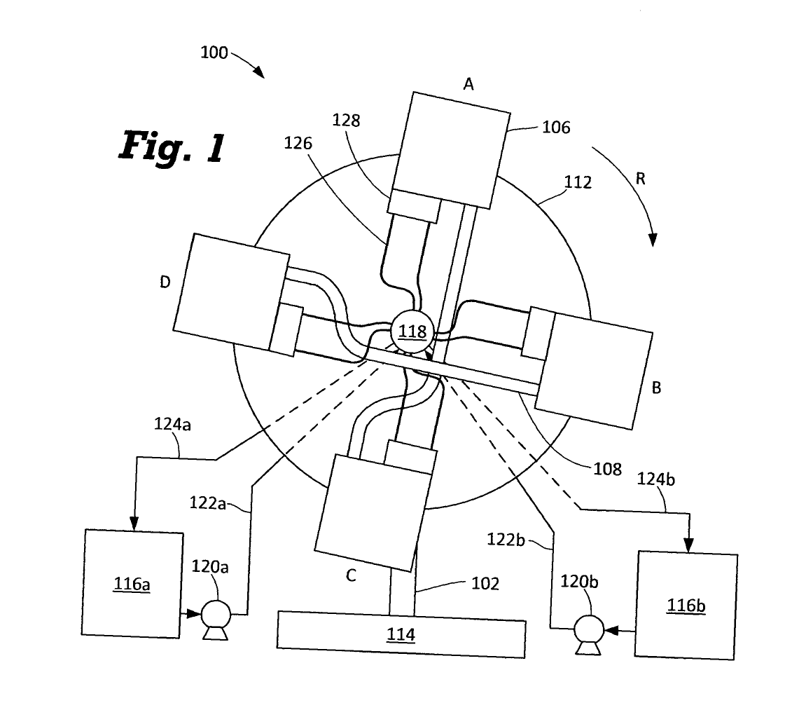

FIG. 1 shows a schematic diagram of an engine 100 configured to extract energy from a heat source according to an embodiment of this disclosure. The engine 100 includes a support 102, a plurality of vessels 106, a plurality of conduits 108 connecting the plurality of vessels 106 together, and a frame 112 to which the vessels 106 are attached. The frame 112 is rotatably connected to the support 102, which allows the wheel-like arrangement of vessels 106 and conduits 108 to rotate in a first direction R about a center of rotation of the frame 112. Power can be taken from the engine 100 by, for example, a shaft (not shown) connected to the frame 112. Such a shaft can be used to rotate an electrical generator to generate electrical power.

The support 102 is a member, frame, or similar rigid structure fixed to a base 114. The support 102 holds the engine 100 apart from the base 114 (for example, above the base), so that the rotatable part of the engine 100 can rotate.

The frame 112 is rotatably connected to the support 102. The frame 112 can be connected to the support 102 by bearings to reduce rotational friction. The frame 112 can be a disc-shaped member, as shown, or can be made of one or more structural members. The bulk of the engine 100 is connected to the frame 112 and rotates with the frame 112 in direction R.

Each vessel 106 is in communication with at least one other vessel 106 via at least one of the conduits 108. In this embodiment, each pair of vessels 106 is connected to ends of a conduit 108, thereby allowing communication between pairs of vessels 106 for flow of fluid or other mass.

As the engine 100 rotates, mass is motivated to move from a lower vessel 106 to an upper vessel 106 to increase potential energy that may then be extracted from the engine 100 in the form of kinetic energy of rotation of the engine 100. At the example position shown in FIG. 1, mass is transferred from the vessel 106 at position “C” to the vessel 106 at position “A”. The vessel 106 at position “B” has previously undergone a similar transfer of mass from the vessel at position “D”. Accordingly, a gravitational moment unbalances the engine 100 causing the vessels 106 and attached frame 112 and conduits 108 to rotate in the direction R. When the vessel 106 at position “B” arrives at position “C”, mass is transferred from the newly arriving vessel 106 to its paired vessel 106 to continue the rotation. Thus, the movement of mass between pairs of vessels 106 rotates the engine 100, so that power can be extracted to do work.

Mass is moved from a lower vessel 106 to an upper vessel 106 by way of an expanding volatile material within the lower vessel 106. Volatile material in each vessel 106 is at least partially expanded by way of a temperature distribution system that includes a heat source 116a, a cooling source 116b, a manifold 118, and a fluid conveying system, i.e., gravity fed or by way of a machine, such as a pumps 120a and 120b.

The volatile material is described herein as being expanded and contracted. This can be achieved by performing one or more of the following on the volatile material: boiling, vaporizing, condensing, increasing a vapor pressure, and decreasing a vapor pressure. In addition, such processes need not be complete. For example, the volatile material may be only partially boiled such that some liquid remains.

Examples of volatile materials include alcohol (e.g., ethanol or methanol), ammonia, water, petroleum ether, benzine, pentane-n, diethyl ether, dimethyl ether, methyl acetate, methyl iodide, ether, ethyl bromide, methanol, hexane, acetone, butane-n, carbon disulfide, bromine, chloroform, acetaldehyde, carbon dioxide, and Freon refrigerants. The volatile material can provided as a liquid, vapor, gas, or combination of such. It will be appreciated that this list of examples of volatile materials is not exhaustive, and other volatile materials that have suitable vaporization points and that may be safely contained in the vessels 106 may also be used.

The mass is selected to provide a sufficient weight to produce a gravitational moment sufficient to rotate the engine 100. Examples of masses include liquids, gels; suspensions, colloids, thixotropic pastes, solids such as particulates (e.g., tungsten particulate), sand, ball bearings, spherical nanoparticles, and similar flowable materials. Such liquids can include water, oils, iodine, mercury, and other high-density liquids. Solid or particulate flowable materials may have their flowability aided by addition of a liquid, lubricant, or surfactant, or by being coated with a low-friction coating. This list of examples of masses is not exhaustive, and other suitable masses that have sufficient flowability within the conduits 108 and vessels 106 may also be used.

The conduits 108 and vessels 106 can have their internal surfaces coated with a low-friction coating, such as Teflon, to reduce friction to improve the movement of the mass.

The pump 120a conveys heated fluid from the heat source 116a to the manifold 118 via a supply conduit 122a. After the engine 100 extracts heat from the heated fluid, fluid of decreased temperature returns to the heat source 116a via a return conduit 124a.

Likewise, the pump 120b conveys cooled fluid from the cooling source 116b to the manifold 118 via a supply conduit 122b. After the engine 100 uses the cooled fluid for cooling, fluid of increased temperature returns to the cooling source 116b via a return conduit 124b.

Examples of heat sources 116a include fluids such as water (or other liquid) warmed by, for example, commercial, industrial, transportation, or residential processes (e.g. warm waste water), solar rays, geothermal heat sources, ocean thermal sources, decomposing biomass, body heat of humans (or other living mammals), heat produced from operation of electronics, exhaust gases, and similar sources of heat.

Examples of cooling sources 116b include radiators, evaporating tanks, reservoirs, naturally occurring ice or snow, and the like.

The manifold 118 distributes fluid from the heat source 116a and cooling source 116b to the vessels 106 and collects returned fluid and returns it to the sources 116a, 116b. The engine 100 further includes distribution conduits 126 (also individually called out as 126a-d) coupled to the manifold 118 through which heated and cooled fluid flows. Each vessel 106 is provided with a heat exchange chamber 128 in which, at times, heat from fluid is transferred to the volatile material of the vessel 106 and, at other times, heat in the volatile material is transferred to the fluid. Specifically, for a given pair of conduit-connected vessels 106 positioned at different elevations at a given time, heat from fluid in the heat exchange chamber 128 of the lower positioned vessel 106 heats and thus expands volatile material in the lower positioned vessel 106, while volatile material in the higher positioned vessel 106 transfers heat to relatively cool fluid in the respective heat exchange chamber 128 to contract or condense volatile material in the higher positioned vessel 106.

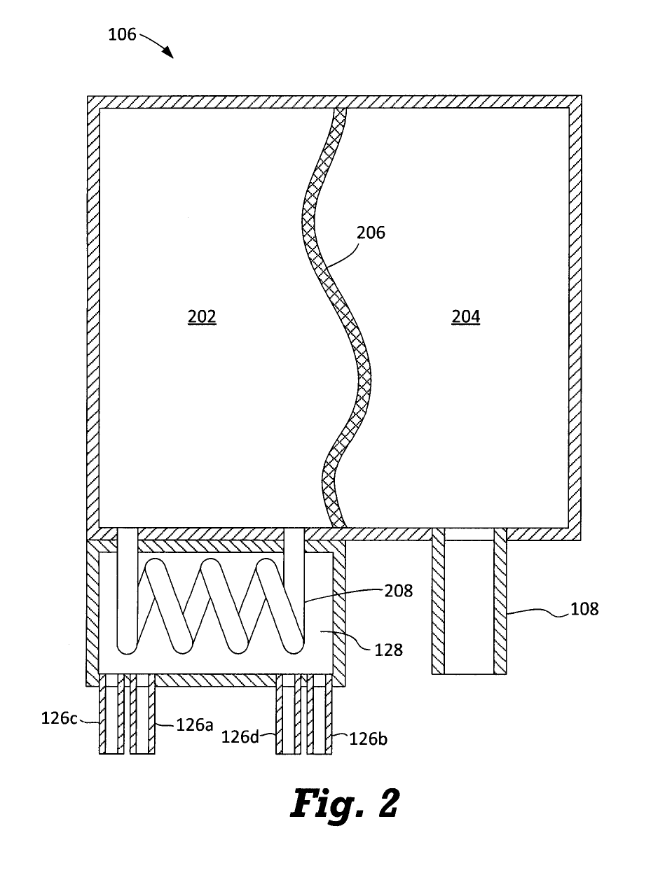

FIG. 2 shows a detailed view of one of the vessels 106.

The body of the vessel 106 may be made of thermally insulative material, such as a plastic (e.g., polypropylene). The interior of the vessel 106 is divided into two chambers, a first chamber 202 containing volatile material and a second chamber 204 containing the mass that is moved between a pair of joined vessels 106 through the conduit 108. The first and second chambers 202, 204 are separated by a flexible membrane 206, so as to prevent mixing of the volatile material and the mass.

The membrane 206 can be made of a material such as polyethylene or polypropylene film, silicone rubber, polymer coated or impregnated fabric, or other material. In another embodiment, the membrane 206 is a combination of sealing material, such as silicone rubber, and a thermally insulative fabric made from a ceramic, such as Nextel. In another embodiment, the membrane is molded silicone rubber with a composite mix of ceramic insulative material or other insulative fibers or nodules. In another embodiment, the membrane 206 can include a nanoparticle, such as carbon black, to prevent permeation of volatile material. The membrane 206 is deformable (i.e., can non-permanently change shape), but need not be elastic or resilient. However, in some embodiments, the membrane can be elastic or resilient. The material of the membrane 206 can be chosen to be thermally insulative, which can assist in preventing heat transfer between the first and second chambers 202, 204.

Communicating with the first chamber 202 containing the volatile material is a heat exchange coil 208 that also contains volatile material. The heat exchange coil 208 can be made of a thermally conductive material, such as copper, other metal, or another material that allows for relatively quick heat transfer between the volatile material within the coil 208 and the heated or cooled fluid external to the coil 208. The coil 208 can have one or more windings, which can be circular (as shown) or can follow another path (e.g., zigzagging). The cross-sectional shape of coil 208 can be round, rectangular, or other shape. The coil 208 can have surface roughness on any of the outside and inside surfaces to increase heat transfer. At any given time, the first chamber 202 and the heat exchange coil 208 can contain volatile material at any state, such as liquid, liquid-gas mixture, or gas.

The heat exchange coil 208 is located inside the heat exchange chamber 128, which is communicated with distribution conduits 126a-d. The heat exchange chamber 128 may be made of thermally insulative material, such as a plastic (e.g., polypropylene), and may be made of the same material as the vessel 106.

When heated fluid is fed into the heat exchange chamber 128 via one of the distribution conduits 126a-d, heat from the heated fluid expands volatile material in the heat exchange coil 208, which causes the volatile material to expand into the first chamber 202 and apply pressure to the membrane 206. The membrane 206 changes shape and pushes the mass present in the second chamber 204 through the conduit 108 into the second chamber 204 of the connected vessel 106. The fluid in the heat exchange chamber 128 has heat extracted there-from and is cooled during this process and exits via another one of the distribution conduits 126a-d.

Likewise, when cooled fluid is fed into the heat exchange chamber 128 via one of the distribution conduits 126a-d, the cooled fluid absorbs heat from volatile material in the heat exchange coil 208, which causes the volatile material to contract and apply a negative pressure (i.e., suction) to the membrane 206. The membrane 206 flexes and pulls mass into the second chamber 204 from the second chamber 204 of the connected vessel 106. The fluid in the heat exchange chamber 128 is heated during this process and leaves via another one of the distribution conduits 126a-d.

A pair of vessels 106 can be operated in synchronization so that the lower vessel 106 tends to push the mass into the higher vessel 106 by positive pressure, while, at the same time, the higher vessel 106 tends to suck the mass from the lower vessel 106 by negative pressure.

Fluid of any temperature can flow in any direction through the distribution conduits 126a-d. The following are examples of various configurations. The temperatures indicated neglect losses.

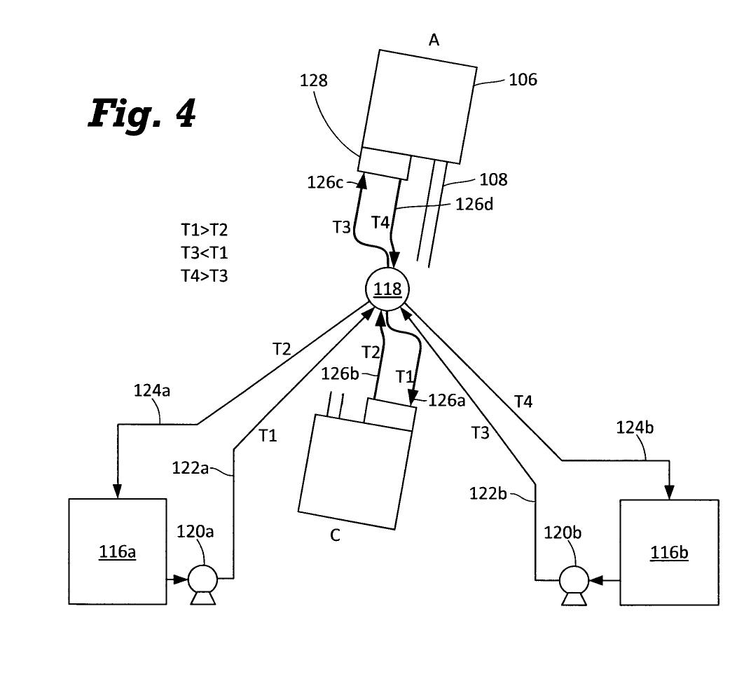

A first configuration is shown in FIG. 4. Some components of the engine 100 are omitted from FIG. 4 for clarity. Heated fluid at a temperature T1 is delivered by the heat source 116a to the manifold 118 via the supply conduit 122a. The fluid at temperature T1 is directed by the manifold 118 to the distribution conduit 126a, so that fluid at temperature T1 enters the heat exchange chamber 128 of a particular vessel 106 at position “C” and transfers heat to the coil 208 (FIG. 2), thereby causing an expansion of the volatile material therein. In doing so, the fluid temperature is reduced to a lower temperature T2. The positional timing of this heating of the volatile material is coordinated to occur when the vessel 106 containing the volatile material is in proximity to bottom dead center (e.g., at or near position “C”). Fluid at temperature T2 exits the heat exchange chamber 128 via conduit 126b to return to the manifold 118, which returns the fluid via the return conduit 124a to the heat source 116a to heat the fluid back to temperature T1.

In the first configuration, as coordinated with the above, the vessel 106 at position “A”, which is paired via a mass-conveying conduit 108 to the vessel 106 at position “C”, is controlled to create contraction of the volatile material within its chamber 202 when in proximity to the top of the wheel (e.g., at or near position “A”). Cooled fluid from the cooling source 116b is delivered at a temperature T3 via the supply conduit 122b to the rotary manifold 118. The manifold 118 is designed to reduce or prevent mixing between hot and cool fluids therein. The manifold 118 delivers the fluid at temperature T3 through distribution conduit 126c to the heat exchange chamber 128 to cool the coil 208 and thereby cause contraction of volatile material within the coil 208 and the connected chamber 202 of the vessel at position “A”. After extracting heat from the volatile material, the fluid has an increased temperature T4 and exits the heat exchange chamber 208 via conduit 126d. The fluid at temperature T4 is then directed through the manifold 118 and returned via the return conduit 124b to the cooling source 116b to be cooled back down to temperature T3.

In the first configuration, the pathway of fluid from the heat source 116a is to flow to and from vessels 106 when at position “C” and the pathway of fluid from the cooling source 116b is to flow to and from vessels 106 when at position “A”.

The expansion and contraction of volatile material causes movement of mass from the vessel 106 at position “C” to the vessel 106 at position “A” to rotate the engine 100. The other pairs of vessels undergo the same process, thereby causing the engine to continually rotate in the direction R.

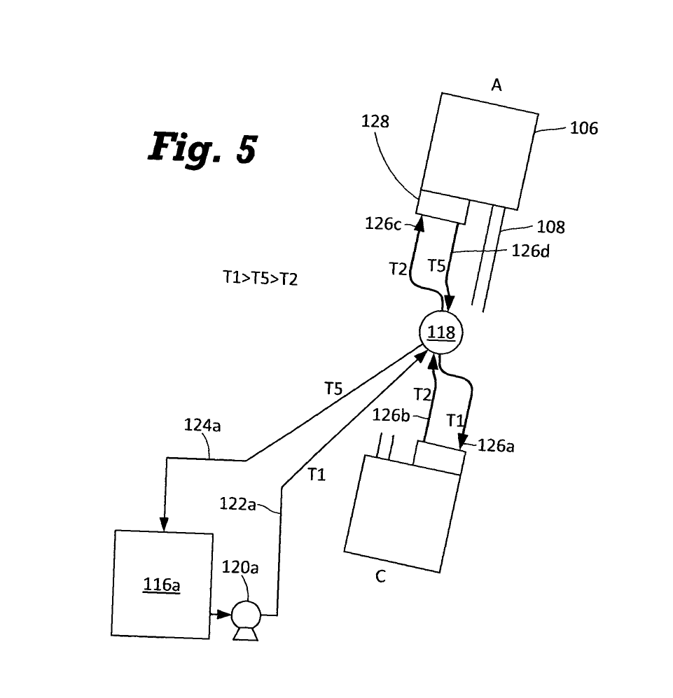

A second configuration is shown in FIG. 5. Some components of the engine 100 are omitted from FIG. 5 for clarity. Heated fluid at a temperature T1 is delivered by the heat source 116a to the manifold 118 via the supply conduit 122a. The fluid at temperature T1 is directed by the manifold 118 to the distribution conduit 126a, so that fluid at temperature T1 enters the heat exchange chamber 128 of a vessel 106 at position “C” and transfers heat to the coil 208 (FIG. 2), thereby causing an expansion of the volatile material therein. In doing so, the fluid temperature is reduced to a lower temperature T2. The positional timing of this heating of the volatile material is coordinated to occur when the vessel 106 containing the volatile material is in proximity to bottom dead center (e.g., at or near position “C”). Fluid at temperature T2 exits the heat exchange chamber 128 via conduit 126b to return to the manifold 118, which directs the fluid to a paired vessel 106 at position “A”.

In the second configuration, as coordinated with the above, the vessel 106 at position “A”, which is paired via a mass-conveying conduit 108 to the vessel 106 at position “C”, is controlled to create contraction of the volatile material within its chamber 202 when in proximity to the top of the wheel (e.g., at or near position “A”). The manifold 118 delivers the fluid at temperature T2 through distribution conduit 126c to the heat exchange chamber 128 to cool the coil 208 and thereby cause contraction of volatile material within the coil 208 and the connected chamber 202. After extracting heat from the volatile material, the fluid has an increased temperature T5 and exits the heat exchange chamber 208 via conduit 126d. The fluid at temperature T5 is then directed through the manifold 118 and returned via the return conduit 124a to the heating source 116a to be again be raised to temperature T1.

If the temperature T2 of the fluid entering the heat exchange chamber 128 of the vessel at position “A” needs to be lower, additional cooling can be provided at the manifold 118 or conduit 126c or by a remote cooling source such as described by item 116b in FIG. 4.

In the second configuration, the pathway of fluid from the heat source 116a is to flow to a vessel 106 when at position “C” and then to the paired vessel 106 at position “A” before returning to the heat source 116a.

The expansion and contraction of volatile material causes movement of mass from the vessel 106 at position “C” to the vessel 106 at position “A” to rotate the engine 100. The other pairs of vessels undergo the same process, thereby causing the engine to continually rotate in the direction R.

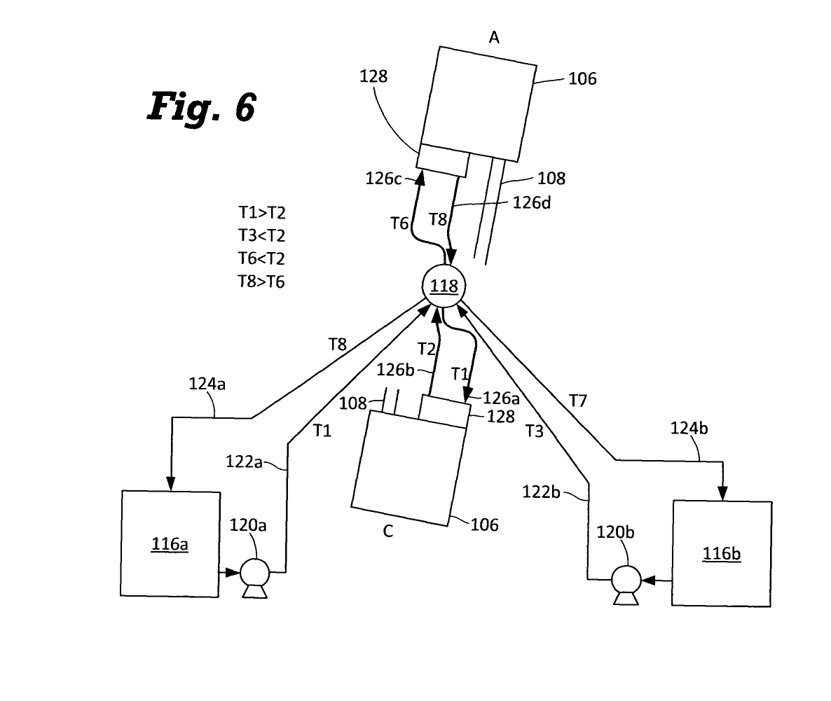

A third configuration is shown in FIG. 6. Some components of the engine 100 are omitted from FIG. 6 for clarity. Heated fluid at a temperature T1 is delivered by the heat source 116a to the manifold 118 via the supply conduit 122a. The fluid at temperature T1 is directed by the manifold 118 to the distribution conduit 126a, so that fluid at temperature T1 enters the heat exchange chamber 128 of a vessel 106 at position “C” and transfers heat to the coil 208 (FIG. 2), thereby causing an expansion of the volatile material in the coil 208. In doing so, the fluid temperature is reduced to a lower temperature T2. The positional timing of this heating of the volatile material is coordinated to occur when the vessel 106 containing the volatile material is in proximity to bottom dead center (e.g., at or near position “C”). Fluid at temperature T2 exits the heat exchange chamber 128 via conduit 126b to return to the manifold 118, which directs the fluid to a paired vessel 106 at position

In the third configuration, as coordinated with the above, the vessel 106 at position “A”, which is paired via a mass-conveying conduit 108 to the vessel 106 at position “C”, is controlled to create contraction of the volatile material within its chamber 202 when in proximity to the top of the wheel (e.g., at or near position “A”). Cooled fluid at a temperature T3 from the cooling source 116b is delivered to the manifold 118. At the manifold 118, fluid at temperature T2 leaving the vessel 106 at position “A” transfers some of its heat to the incoming fluid at temperature T3. This can be by direct mixing of the fluids at temperatures T2 and T3 or by non-mixing heat exchange. Fluid warmed by this process can be returned to the cooling source 116b via return conduit 124b at temperature T7. The manifold 118 then delivers fluid at temperature T6, which has been cooled from temperature T2 by the fluid at temperature T3, through distribution conduit 126c to the heat exchange chamber 128 to cool the coil 208 and thereby cause contraction of volatile material within the coil 208 and the connected chamber 202. After extracting heat from the volatile material, the fluid has an increased temperature T8 and exits the heat exchange chamber 208 via conduit 126d. The fluid at temperature T8 is then directed through the manifold 118 and returned via the return conduit 124a to the heating source 116a to be again be raised to temperature T1.

In the third configuration, the pathway of fluid from the heat source 116a is to flow to a vessel 106 when at position “C” and then to the paired vessel 106 at position “A” before returning to the heat source 116a. The pathway of fluid from the cooling source 116b is to flow to and from the manifold 118, in order to cool fluid moving from the vessel 106 at position “C” to the vessel 106 at position “A”. In other embodiments the cooling of fluid at temperature T2 by fluid at temperature T3 can be performed at other locations, such as at the conduit 126b or 126c or at the heat exchange chamber 128 of the vessel 106 at position “A”.

The expansion and contraction of volatile material causes movement of mass from the vessel 106 at position “C” to the vessel 106 at position “A” to rotate the engine 100. The other pairs of vessels undergo the same process, thereby causing the engine to continually rotate in the direction R.

An efficiency of the engine 100 operating according to the third configuration can be expressed as:

e=Wout/Qin_{—}net

where

Wout is work obtained from the engine 100 by way of its rotation; and

Qin_net is net heat entering the engine 100 and is proportional to T1-T8.

With other factors being equal, the engine 100 in the third configuration (FIG. 6) has a higher efficiency than the engine 100 in the first configuration (FIG. 4) due to the difference of temperatures T1-T8 (in FIG. 6) being lower than the difference of temperature T1-T2 (in FIG. 4).

In the third configuration shown in FIG. 6, it can be seen that the exhaust (i.e., cooled fluid output) of one vessel 106 is used in the cooling of another vessel 106. This is different from a turbo-capable internal combustion engine, which uses exhaust to preheat input air.

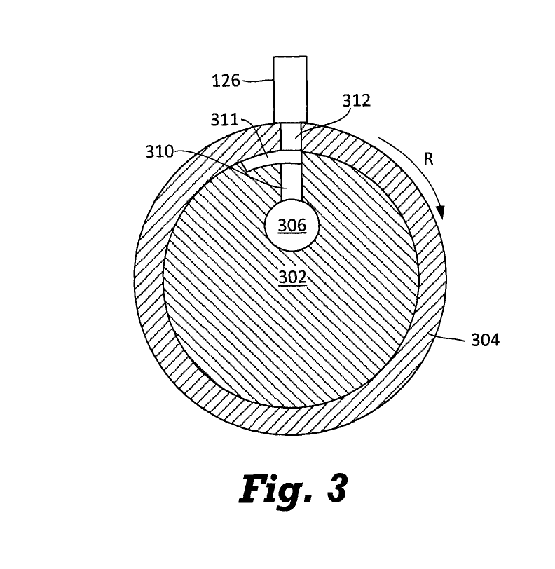

FIG. 3 shows a cross-section of the manifold 118, which is a generally cylindrical or barrel-shaped body. The manifold 118 has a cylindrical inner shaft 302 and a hollow cylindrical outer tube 304. The outer tube 304 is rotatable about the inner shaft 302, which is fixed and can be secured to the support 102 (FIG. 1). The outer tube 304 is connected to the distribution conduits 126 and rotates with the vessels 106 and the frame 112. A power-extracting shaft can be connected to the outer tube 304 to extract power from the engine 100.

The inner shaft 302 can have any number of channels for conveying fluid to or from the sources 116a, 116b. In FIG. 3, one channel 306 is shown for clarity. Channels in the inner shaft 302 can be separate from each other or can be interconnected.

The inner shaft 302 has at least one radial channel 310 that communicates the channel 306 to a circumferential channel 311, which selectively communicates with one or more of the distribution conduits 126 via port 312 in the outer tube 304. The circumferential channel 311 communicates the channel 310 to a distribution conduit 126 over a predetermined angular range of rotation of the outer tube 304, so that fluid flow between the manifold 118 and the vessel 106 served by the distribution conduit 126 can be controlled.

A plurality of channels 306, channels 310, 311, and ports 312, can be arranged and sized to provide fluid to or receive fluid from any of the distribution conduits 126a-d as the outer tube 304 rotates with respect to the inner shaft 302. The duration and timing of fluid movement between the sources 116a, 116b and the vessels 106 can be thus controlled. Any configuration of fluid flow pathways, such as those of FIGS. 4, 5, 6 and 7, can be realized in this manner.

The outer tube 304 and inner shaft 302 can be engaged in a sealing manner by, for example, O-rings provided to the outside surface of the inner shaft 302.

The manifold 118 is merely one example of a way of distributing fluid to the engine.

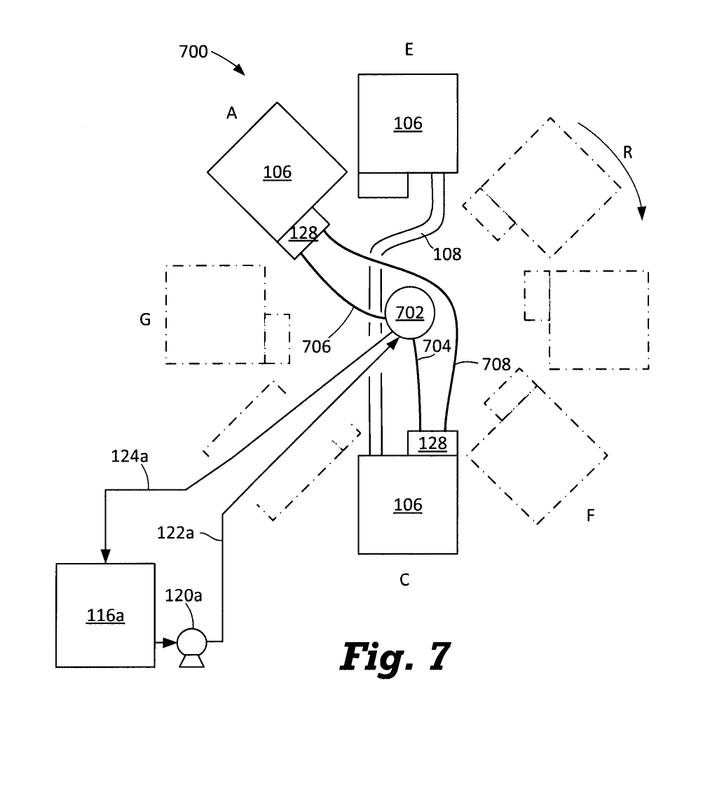

FIG. 7 shows an engine 700 according to another embodiment. Features and aspects of the engine 700 are similar to those of the engine 100 and the above description can be referenced. Some components are omitted from FIG. 7 for clarity, such as the support 102, the base 114, the frame 112, and some of the conduits 108. Vessels 106 not specifically discussed are shown in phantom line for clarity, and the description for the vessels 106 that are discussed can be referenced.

The engine 700 includes eight vessels 106. Vessels 106 are connected in pairs by conduits 108, as described with reference to the engine 100, to move mass between the paired vessels 106 to cause the engine 700 to rotate. For example, the vessel 106 at position “C” is connected via a conduit 108 to the vessel 106 at opposite position “E”, and the same applies for the vessels 106 at positions “A” and “F” and so on.

In this embodiment, distribution of heated fluid is between pairs of vessels 106 that are not the same pairs as defined by the conduit 108 connections. Regarding distribution of heated fluid from the heat source 116a to a thermally connected pair of vessels 106, a first distribution conduit 704 is connected from a manifold 702 to the heat exchange chamber 128 of one of the vessels 106, which is located at position “C”. A second distribution conduit 706 is connected from the manifold 702 to the heat exchange chamber 128 of the other one of the vessels 106, which is located at position “A”, which is not opposite position “C”. A third distribution conduit 708 connects the heat exchange chambers 128 of the two vessels 106. The vessels 106 at positions “F” and “G” are thermally paired in the same manner, and so on for the remaining vessels 106.

The manifold 702 is configured to selectively connect the first and second distribution conduits 704, 706 to the heat source supply and return conduits 122a, 124a. In the positions shown, the vessel 106 at position “C” is connected to the heat source supply conduit 122a, while the vessel at position “A” is connected to the return conduit 124a. Accordingly, fluid flows into the heat exchange chamber 128 of the vessel 106 at position “C”, causes the volatile material in the vessel 106 at position “C” to expand to push the mass into the vessel 106 at position “A”, and exits the heat exchange chamber 128 via the third distribution conduit 708 at a lower temperature. The fluid leaving exchange chamber 128 of the vessel 106 at position “C” via the third conduit 708 enters the heat exchange chamber 128 of the vessel 106 at position “A”. Since this fluid has been cooled by the thermal interaction with the volatile material in the vessel 106 at position “C”, this fluid acts to cool the volatile material in the vessel 106 at position “A” to cause the volatile material to condense and suck the mass from the vessel 106 at position “F” into the vessel 106 at position “A”. Additional cooling can be provided to the fluid that travels through the third distribution conduit 708 from the cooling source 116b, as discussed elsewhere herein. The fluid in the heat exchange chamber 128 at the vessel at position “A” warms and exits via the second conduit 706 to the manifold 702 where it is output at the heat source return conduit 124a. Thus, the cooled fluid output by one vessel 106 acts to cool the volatile material in the paired vessel 106.

In other words, the manifold 702, conduits 704, 706, 708, and heat exchange coils 208 are configured in a pathway for conveying fluid heated by the heat source 116a. The pathway extends from the heat source 116a through the supply conduit 122a to whichever vessel 106 of the thermally connected pair is lower, from the lower vessel 106 to the upper vessel 106, and then from the upper vessel 106 back to the heat source 116a via the return conduit 124a. The pathway of fluid is similar to that of FIG. 5.

In this embodiment, position “A” is somewhat behind the 180-degree opposite position “E”, however, momentum of the engine 700 and the time required to expand and condense the volatile material will result in a moment in the direction R by the time the vessel 106 at position “A” reaches or passes position “E”.

In this embodiment, each of the vessels 106 in the engine 700 is thermally paired to one of the other vessels 106 and paired for mass conveyance to a different one of the others vessels 106, as described above for the example vessels 106, thereby causing the engine 700 to continually rotate in the direction R.

Aspects of the engine 100 (e.g., the number and arrangement of vessels, the arrangement of conduits 126, and the cooling source 116b) can be used with the engine 700. Aspects of the engine 700 (e.g., the number and arrangement of vessels and the arrangement of conduits 704, 706, 708) can be used with the engine 100.

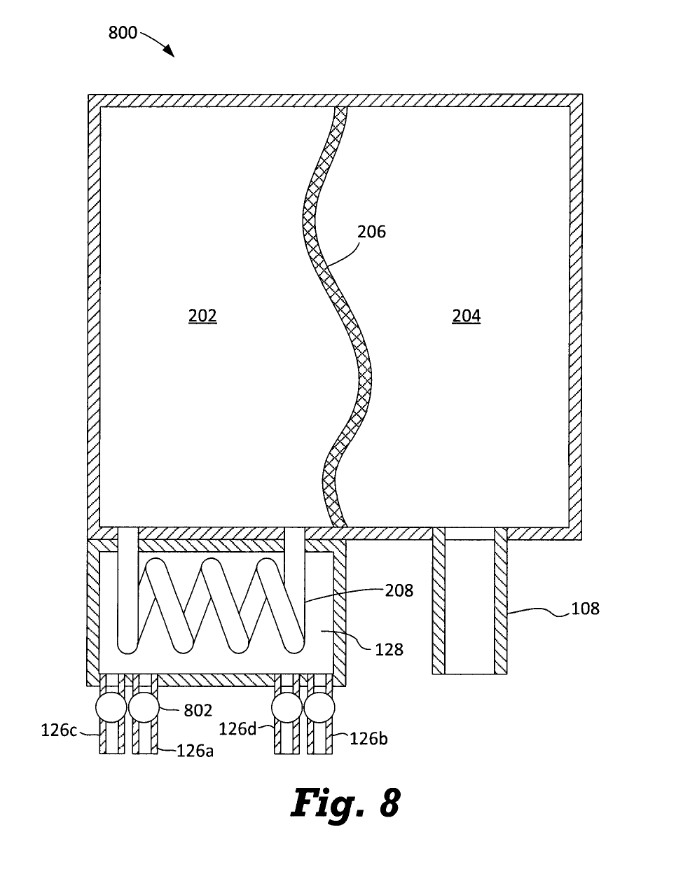

FIG. 8 shows another embodiment of a vessel 800. The vessel 800 is similar to the vessel 106 and the above description can be referenced for like components. The vessel 800 can be used in any of the engines described herein, such as the engines 100 and 700.

A valve 802 is provided at each of the distribution conduits 126a-d to control flow of fluid into and out of the heat exchange chamber 128. Each of the valves 802 can be opened and closed according to a timing pattern based on the position of the vessel 800 as it rotates in the engine. The valves 802 can be electrically controllable valves, such as solenoid valves, and can be controlled according to a program to time delivery of fluid. Alternatively or additionally, the controllable valves 802 can be actuated by mechanical, pneumatic, hydraulic, magnetic, piezo, or other technique.

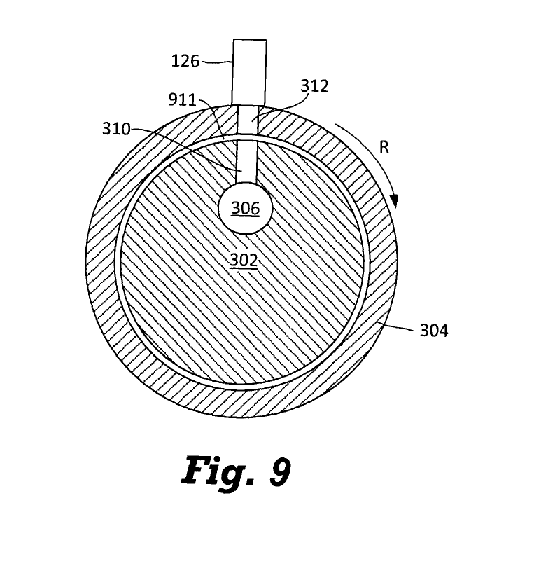

FIG. 9 shows another embodiment of a manifold 900. The manifold 900 is similar to the manifold 118 and the above description can be referenced for like components. The manifold 900 can be used in any of the engines described herein, such as the engines 100 and 700.

A circumferential channel 911 extends over the entire circumference of the inner shaft 302 of the manifold 900. This allows communication of the channel 306 with the distribution conduit 126 regardless of rotational angle of the outer tube 304 with respect to the inner shaft 302. Control of flow of fluid between the manifold 900 and the distribution conduits 126 can be performed in another manner, such as via the valves 802 of the vessel 800 of FIG. 8.

A plurality of separate circumferential channels 911, each served its own channels 306, 310, 312, can be provide for fluids of different temperatures. The plurality of separate circumferential channels 911 can be separated longitudinally from each other (into the page).

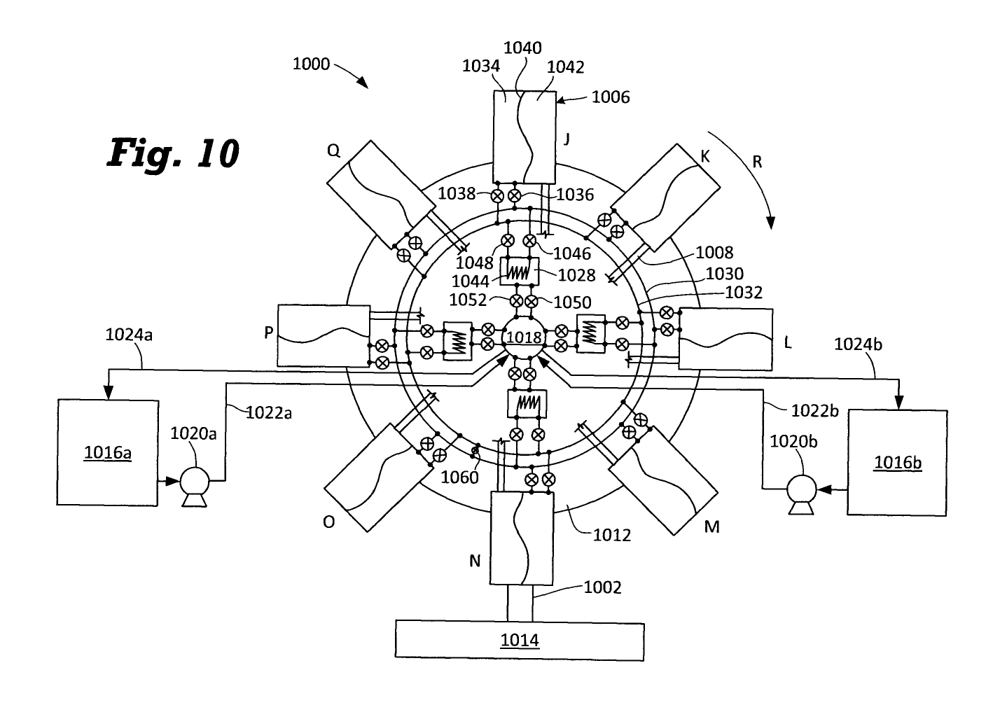

FIG. 10 shows a schematic diagram of an engine 1000 configured to extract energy from a heat source according to another embodiment of this disclosure. Features and aspects of the engine 1000 can be used with the other engines described herein, and vice versa. Reference numerals in the 1000s series are used to describe the engine 1000, and the description of components having like numerals in the 100s series can be referenced.

The engine 1000 includes a support 1002 connected to a base 1014, a plurality of vessels 1006, a plurality of conduits 1008 connecting the plurality of vessels 1006 together, and a frame 1012 to which the vessels 1006 are attached. The frame 1012 is rotatably connected to the support 1002, which allows the wheel-like arrangement of vessels 1006 and conduits 1008 to rotate in a first direction R about a center of rotation of the frame 1012. Power can be taken from the engine 1000 by, for example, a shaft (not shown) connected to the frame 1012. Such a shaft can be used to rotate an electrical generator to generate electrical power.

Each vessel 1006 is in communication with at least one other vessel 1006 via at least one of the conduits 1008. In this embodiment, the vessels 1006 may be positioned opposite each other at locations around the frame 1012. Each pair of opposing vessels 1006 is connected by one of the conduits 1008, thereby allowing communication between oppositely positioned pairs of vessels 1006 for flow of fluid or other mass. For example, the vessel 1006 at position “J” is connected to the vessel 1006 at position “N”, and so on. The continuous lengths of the conduits 1008 are not illustrated for sake of clarity. Movement of mass via the conduits 1008 between pairs of vessels 1006 rotates the engine 1000, as described elsewhere herein (e.g., see engine 100), so that power can be extracted to do work.

Mass is moved from a mass chamber 1042 of a lower vessel 1006 to a mass chamber 1042 of an upper vessel 1006 via the connecting conduit 1008 by way of expanding volatile material within the lower vessel 1006 (e.g., position “N”) and contracting volatile material within the upper vessel 1006 (e.g., position “J”). Volatile material in each vessel 1006 is at least partially expanded or contracted by way of a temperature distribution system that includes a heat source 1016a, a cooling source 1016b, a rotary manifold 1018, and a fluid conveying system, i.e., gravity fed or by way of a machine, such as a pumps 1020a and 1020b. The pump 1020a conveys heated fluid from the heat source 1016a to the manifold 1018 via a supply conduit 1022a. The manifold 1018 can be similar to or the same as the manifold 900 of FIG. 9 to allow conveyance and distribution of fluids at different temperatures while still relative allowing mechanical rotation. After the engine 1000 extracts heat from the heated fluid, fluid of decreased temperature returns to the heat source 1016a via a return conduit 1024a. Likewise, the pump 1020b conveys cooled fluid from the cooling source 1016b to the manifold 1018 via a supply conduit 1022b. After the engine 1000 uses the cooled fluid for cooling, fluid of increased temperature returns to the cooling source 1016b via a return conduit 1024b.

The engine 1000 further includes a pressure distribution system configured to convert thermal energy, such as heated or cooled fluid, to pressure, such as positive (high) or negative (low) relative pressure. Negative relative pressure may also be known as partial vacuum, suction, or low pressure. The pressure distribution system contains volatile material.

The pressure distribution system includes a plurality of heat exchange chambers 1028, a high-pressure distribution line 1030, and a low-pressure distribution line 1032. A pressure chamber 1034 of each vessel 1006 is connected to the high-pressure distribution line 1030 by a controllable vessel-high valve 1036 and is connected to the low-pressure distribution line 1032 by a controllable vessel-low valve 1038. As controlled by the valves 1036, 1038, positive or negative pressure in the pressure chamber 1034 pushes or pulls a separator 1040 (e.g., a membrane or similar, such as membrane 206) to reduce or increase the volume of adjacent mass chamber 1042 to push or induce mass to flow out of or into the vessel 1006.

The pressure distribution system further includes a coil 1044 (e.g., coil 208) in each of the heat exchange chambers 1028. Each coil has at one end a controllable coil-high valve 1046 connected to the high-pressure distribution line 1030 and a controllable coil-low valve 1048 connected to the low-pressure distribution line 1032. The heat exchange chambers 1028 serve to bring heated or cooled fluid from the sources 1016a, 1016b into contact with the coils 1044 so as to expand or contract volatile material within the coils 1044 in order to contribute to the pressures in the high and low distribution lines 1030, 1032, as controlled by the valves 1046, 1048. To effect this, heated and cooled fluid flow from the manifold 1018 into each of the heat exchange chambers 1028 is controlled by a heated-fluid valve 1050 and a cooled-fluid valve 1052, which, with the manifold 1018, form part of the temperature distribution system.

The pressure distribution system rotates with the frame 1012, vessels 1006, conduits 1008, and the rest of the rotating portion of the engine 1000. The rotating portion of the manifold 1018 and the valves 1050, 1052 of the temperature distribution system also rotate with the rotating portion of the engine 1000.

An optional flow control device 1060 may be provided to selectively connect the high and low pressure distribution lines 1030, 1032. The flow control device 1060 can include one or more of a pump and a check valve.

In this embodiment, the engine 1000 has fewer coils 1044 (i.e., four) than vessels 1006 (i.e., eight). In another embodiment, the engine 1000 can have more coils 1044 than vessels 1006. In yet another embodiment, the engine 1000 can have the same number of coils 1044 as vessels 1006.

The controllable valves 1036, 1038, 1046, 1048, 1050, 1052 can be electrically controlled valves, such as solenoid valves, or can be actuated by mechanical, pneumatic, hydraulic, magnetic, piezo, or other technique. The controllable valves 1036, 1038, 1046, 1048, 1050, 1052 can be different from each other and need not all be of the same type. The controllable valves 1036, 1038, 1046, 1048, 1050, 1052 can be connected to a computer via wired or wireless connections and be software controlled. The vessel pressure valves 1036, 1038 allow the pressure applied to the each vessel 106 to be controlled independently from the pressure applied to the high and low pressure distribution lines 1030, 1032 by the coils 1044. The coil pressure valves 1046, 1048 allow pressure applied to the high and low pressure distribution lines 1030, 1032 to be controlled independently from the flow of fluid into and out of the heat exchange chambers 1028. And likewise, the fluid control valves 1050, 1052 allow temperature applied to the heat exchange chambers 1028 to be controlled independently from the flow of fluid at the manifold 1018.

The engine 1000 can be operated as follows. Heated fluid is pumped into a heated-fluid portion of the manifold 1018 from the heat source 1016a, and cooled fluid is pumped into a cooled-fluid portion of the manifold 1018 from the cooling source 1016b. One or more of the heated-fluid valves 1050 are opened to provide heated fluid to the associated heat exchange chambers 1028. Conversely, one or more of the cooled-fluid valves 1052 are opened to provide cooled fluid to different heat exchange chambers 1028. Volatile material tries to expand within the coils 1044 in the heat exchange chambers 1028 provided heated fluid, while volatile material tries to contract within the coils 1044 in the heat exchange chambers 1028 provided cooled fluid. Accordingly, the coil-high valves 1046 of one or more heated coils 1044 are opened to increase the pressure within the high-pressure distribution line 1030, whereas the coil-low valves 1048 of the one or more heated coils 1044 are kept closed. Likewise, the coil-low valves 1048 of one or more cooled coils 1044 are opened to decrease the pressure within the low-pressure distribution line 1030, whereas the coil-high valves 1046 of the one or more cooled coils 1044 are kept closed. Independent of the above, as a vessel 1006 reaches position “N”, the associated vessel-high valve 1036 is opened and the associated vessel-low valve 1038 is kept closed, so as to fill the pressure chamber 1034 with expanding volatile material and push the separator 1040 to push mass within the mass chamber 1042 into the mass chamber 1042 of the connected vessel 1006 at position “J”. In a coordinated manner, as the connected vessel 1006 reaches position “J”, the associated vessel-low valve 1038 is opened and the associated vessel-high valve 1036 is kept closed, so as to draw volatile material out of the pressure chamber 1034 and induce suction on the separator 1040 to draw mass from the vessel 1006 at position “N” into the mass chamber 1042. Thus, the vessel 1006 at position “J” has increased mass that contributes to the rotational moment as it moves from position “J”, through positions “K”, “L”, and “M, and to position “N”, at which the above process repeats. At the same time, the vessel 1006 at position “N” has decreased mass that reduces the anti-rotational moment as it moves from position “N”, through positions “O”, “P”, and “Q, and to position “J”.

Since control of the vessel-pressure valves 1036, 1038 is independent of the remaining valves 1046, 1048, 1050, 1052, any of the vessels 1006 can be closed off from either or both of the high and low pressure distribution lines 1030, 1032 when such vessel 1006 does not require active positive or negative pressure. However, at the same time, the desired pressures within the high and low pressure distribution lines 1030, 1032 can be maintained by controlling the remaining valves 1046, 1048, 1050, 1052. The movement of mass between vessels 1006 is thus decoupled from the flow of heated or cooled fluid, which advantageously reduces the chance that temperature or fluid flow fluctuations will affect the rotation of the engine 1000.

Another advantage of the engine 1000 is redundancy in that if one or more coils 1044 becomes non-operational, then pressures within the high and low pressure distribution lines 1030, 1032 can still be maintained by the remaining coils 1044.

Yet another advantage of the engine 1000 is that the pressure distribution system rotates with the rotating portion of the engine 1000, so that rotational high-pressure gas/vapor seals are not required. Moving seals are instead provided at the manifold 1018 for the heated and cooled fluid, which are under lower pressures and thus require less complicated sealing.

In any of the embodiments described herein, components used to expand/contract volatile material can be given surface roughness to improve boiling/vaporization/condensation. The same components can be made to vibrate to also improve boiling/vaporization/condensation. Such vibration can be achieved by, for example, affixing piezoelectric vibrators to the outsides of the vessels. A surfactant, such as a detergent, or a nucleating agent can be introduced to a fluid to also improve boiling/vaporization/condensation.

The engines described herein can include other features, such as features disclosed in published international patent applications WO 2009/140752 and WO 2011/057402, which are incorporated herein by reference.

While the above description provides examples of one or more methods and/or apparatuses, it will be appreciated that other methods and/or apparatuses may be within the scope of the present description as interpreted by one of skill in the art.

1. An engine configured to extract energy from a heat source, the engine comprising:
a plurality of vessels coupled to and arranged about a shaft;
a plurality of conduits connecting the plurality of vessels together to convey mass between the vessels;
each of the plurality of vessels being in communication with at least one other of the plurality of vessels via at least one of the conduits, a pressure difference between a lower positioned vessel of the plurality of vessels and a higher positioned vessel of the plurality of vessels causing mass to move from the lower positioned vessel into the higher positioned vessel to produce a gravitational moment that encourages rotation of the plurality of vessels and connected conduits in a first direction, the pressure difference at least in part due to expansion of volatile material at the lower positioned vessel;
a rotary manifold configured to control flow of one or both of heated and cooled fluid from at least one source to the engine; and
a plurality of controllable valves configured to control delivery of one or both of heated and cooled fluid to the volatile material.

2-4. (canceled)

5. The engine of claim 1, wherein the plurality of controllable valves comprises at least an electrically controllable valve, a solenoid valve, a mechanical valve, a pneumatic valve, a hydraulic valve, a magnetic valve, or a piezo valve.

6. The engine of claim 1, wherein at least one of the plurality of controllable valves is connected to a computer and is software controlled.

7-9. (canceled)

10. The engine of claim 1, further comprising a plurality of heat exchange chambers containing volatile material and configured to receive delivery of the one or both of heated and cooled fluid to the volatile material.

11. The engine of claim 10, further comprising a second plurality of controllable valves connected to the plurality of heat exchange chambers and configured to control delivery of volatile material to the inside of the vessels and there-between.

12. The engine of claim 11, wherein at least two heat exchange chambers of the plurality of heat exchange chambers controllably share volatile material there-between.

13. The engine of claim 1, further comprising a pressure distribution system configured to convert thermal energy of one or both of heated and cooled fluid into one or both of positive and negative relative pressure of the volatile material.

14. The engine of claim 10, wherein a number of heat exchange chambers and a number of vessels is different.

15. The engine of claim 1, further comprising means for improving boiling, evaporation, or condensation of volatile material.

16. The engine of claim 15, wherein the means for improving boiling, evaporation, or condensation of volatile material comprises at least one vibrator connected to at least one component of the engine.

17. The engine of claim 15, wherein the means for improving boiling, evaporation, or condensation of volatile material comprises a surfactant, detergent, or nucleating agent.

18. A method of controlling an engine, the method comprising:
volatile material providing pressure to a lower vessel of a plurality of vessels of the engine to tend to push mass from the lower vessel into an upper vessel of the plurality of vessels;
rotating a rotary manifold and controlling valves to convey one or both of heat and cooling to the volatile material to controllably distribute pressure to the plurality of vessels to cause mass to move out of or into each vessel of the plurality of vessels; and
rotating a structure to which the plurality of vessels is connected by a gravitational moment caused by movement of mass between the plurality of vessels.

19-25. (canceled)

26. The method of claim 18, further comprising providing negative relative pressure to the upper vessel to tend to suck mass from the lower vessel into the upper vessel.

27-28. (canceled)

29. The method of claim 18, further comprising conveying one or both of heat and cooling to the volatile material at a plurality of heat exchange chambers containing volatile material.

30. The method of claim 29, further comprising controllably sharing volatile material between at least two of the heat exchange chambers.

31. The method of claim 30, wherein controllably sharing volatile material is performed using at least one controllable valve comprising at least an electrically controllable valve, a solenoid valve, a mechanical valve, a pneumatic valve, a hydraulic valve, a magnetic valve, or a piezo valve.

32. The method of claim 30, wherein the at least one controllable valve is connected to a computer and is software controlled.

33. The method of claim 18, further comprising vibrating at least one component of the engine.
